(19) United States
(12) Patent Application Publication
(10) Pub. No.: US 2014/0019254 A1
(43) Pub. Date: Jan. 16, 2014

(54) LOCATION-BASED DATA PROCUREMENT

(71) Applicant: ODYSII TECHNOLOGIES LTD, Herzeliya (IL)

(72) Inventor: Tal REICHERT, Medford, MA (US)

(21) Appl. No.: 13/938,433

(22) Filed: Jul. 10, 2013

Related U.S. Application Data
(60) Provisional application No. 61/670,282, filed on Jul. 11, 2012.

(51) Int. Cl. G06Q 30/02

(52) U.S. Cl. CPC G06Q 30/0267
USPC 705/14.64; 370/338

(57) ABSTRACT

Disclosed are methods, systems, apparatus, devices, products and other implementations, including a method that includes detecting a signal from an access point located within a geographical area, including identifying the access point based on data included in the signal representative of an identity of the access point. The method further includes establishing through a communication node, different from the access point, a communication link with a remote server in response to detecting the signal from the access point, and receiving from the remote server via the communication node data associated with the geographical area in which the access point is located.

### CROSS-REFERENCE TO RELATED APPLICATIONS

This application claims the benefit of, and priority to, provisional U.S. application Ser. No. 61/670,282, entitled “LOCATION-BASED DATA GENERATION,” and filed Jul. 11, 2012, the content of which is incorporated herein by reference in its entirety.

### BACKGROUND

The widespread use of mobile devices (e.g., smartphones) enables users to quickly and efficiently access any information they require. Such broad access to information can enhance users' experience in performing a wide variety of activities (e.g., retail activities) by providing them with ready access to information they may need in the course of performing such activities.

### SUMMARY

In some variations, a method is disclosed that includes detecting a signal from an access point located within a geographical area, including identifying the access point based on data included in the signal representative of an identity of the access point. The method further includes establishing through a communication node, different from the access point, a communication link with a remote server in response to detecting the signal from the access point, and receiving from the remote server via the communication node data associated with the geographical area in which the access point is located.

Embodiments of the method may include at least some of the features described in the present disclosure, including one or more of the following features.

The access point may include a WiFi-based access point.

The communication node may include a cellular-based communication node.

The geographical area may include a retail outlet.

Receiving the data associated with the geographical area may include receiving from the remote server via the communication node marketing data relating to the retail outlet, with the marketing data including one or more of, for example, marketing promotional data, and/or data relating to purchases by various users.

Detecting the signal may include receiving the signal by a mobile device executing a mobile-based application configured to determine if one or more of received signals include one or more predetermined access-point IDs identifying respective access points, and determining whether the received signal includes data representative of one of the one or more predetermined access-point IDs.

In some variations, a mobile device is disclosed. The mobile device includes one or more processor-based devices, and memory storage devices to store instructions that when executed on the one or more processor-based devices cause operations including detecting a signal from an access point located within a geographical area, including identifying the access point based on data included in the signal representative of an identity of the access point. The operations further include establishing through a communication node, different from the access point, a communication link with a remote server in response to detecting the signal from the access point, and receiving from the remote server via the communication node data associated with the geographical area in which the access point is located.

Embodiments of the mobile device may include at least some of the features described in the present disclosure, including at least some of the features described above in relation to the method.

In some variation, a non-transitory computer readable media programmed with a set of instructions executable on a processor is disclosed. The instructions, when executed, cause operations that include detecting a signal from an access point located within a geographical area, including identifying the access point based on data included in the signal representative of an identity of the access point, establishing through a communication node, different from the access point, a communication link with a remote server in response to detecting the signal from the access point, and receiving from the remote server via the communication node data associated with the geographical area in which the access point is located.

Embodiments of the computer readable media include at least some of the features described in the present disclosure, including at least some of the features described above in relation to the method and the mobile device.

In some variations, another method is provided. The method includes detecting a signal from an access point located within a geographical area, including identifying the access point based on data included in the signal representative of an identity of the access point, and obtaining data associated with the geographical area without establishing a communications link with the access point in response to detecting the signal from the access point.

Embodiments of the other method may include at least some of the features described in the present disclosure, including at least some of the features described above in relation to the first method, the mobile device, and the computer readable media, as well as one or more of the following features.

Obtaining the data associated with the geographical area may include establishing through a communication node, different from the access point, a communication link with a remote server, and receiving from the remote server via the communication node data associated with the geographical area in which the access point is located.

Obtaining the data associated with the geographical area may include retrieving from a mobile device that detected the signal from the access point the data associated with the geographical area.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein.

“Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “or” or “and” as used in a list of items prefaced by “at least one of” or “one or more of” indicates that any combination of the listed items may be used. For example, a list of “at least one of A, B, or C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, or C” (or “one or more of A, B, or C”) may also include A, AA, AAB, AAA, BB, BCC, etc.

As used herein, including in the claims, unless otherwise stated, a statement that a function, operation, or feature, is “based on” an item and/or condition means that the function, operation, function is based on the stated item and/or condition and may be based on one or more items and/or conditions in addition to the stated item and/or condition.

Unless defined otherwise, all technical and scientific terms used herein have the same meaning as commonly understood by one of ordinary skill in the art to which this disclosure belongs.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a schematic diagram of an example system configured to enable obtaining location-based data.

FIG. 2 is a schematic diagram of an example system configured to enable obtaining location-based marketing data.

FIG. 3 is a schematic diagram of an example mobile device.

FIG. 4 is a flowchart of an example procedure to obtain location-based data.

FIG. 5 is a signal diagram showing signal transmissions made by various elements of the systems of FIGS. 1 and/or 2.

FIG. 6 is a schematic diagram of a generic computing system.

Like reference symbols in the various drawings indicate like elements.

### DETAILED DESCRIPTION

Disclosed herein are methods, systems, apparatus, devices, computer program products, and other implementations, including a method that includes detecting (e.g., by a mobile device) a signal from an access point (e.g., a WiFi-based access point, a Bluetooth™ node, etc.) located within a geographical area (e.g., such as a retail outlet), including identifying the access point based on data included in the signal representative of an identity of the access point. The method further includes establishing through a communication node (e.g., a cellular base station, etc.), that is different from the access point, a communication link with a remote server in response to detecting the signal from the access point, and receiving from the remote server via the communication node data associated with the geographical area in which the access point is located. Such data may include marketing materials (e.g., promotional materials) for a retail outlet in which the access point is located and/or for other retail outlets, marketing materials for various goods and services, date relating to purchases made by various users, etc. Thus, in some embodiments, the local access point is used to provide identifying signals (e.g., beacons) to visiting mobile devices without establishing actual communication links with the visiting mobile devices. Consequently, data pertaining to the geographic area is received through links with the communication node (e.g., links that may have been previously established, or need to be established, through normal data roaming operations performed by the mobile device) without requiring users of the visiting mobile devices to take actions to connect their devices to the local access points and/or servers.

In some embodiments, detecting the signal from the access point includes receiving signals by a mobile device executing a mobile-based application configured to determine if one or more of the received signals include one or more predetermined access-point IDs identifying respective access points, and determining whether the received signal includes data representative of one of the one or more predetermined access-point IDs.

In some embodiments, in response to detecting the signal from the access point, the data associated with the geographical area is obtained from the mobile device, e.g., by retrieving it directly from the mobile device.

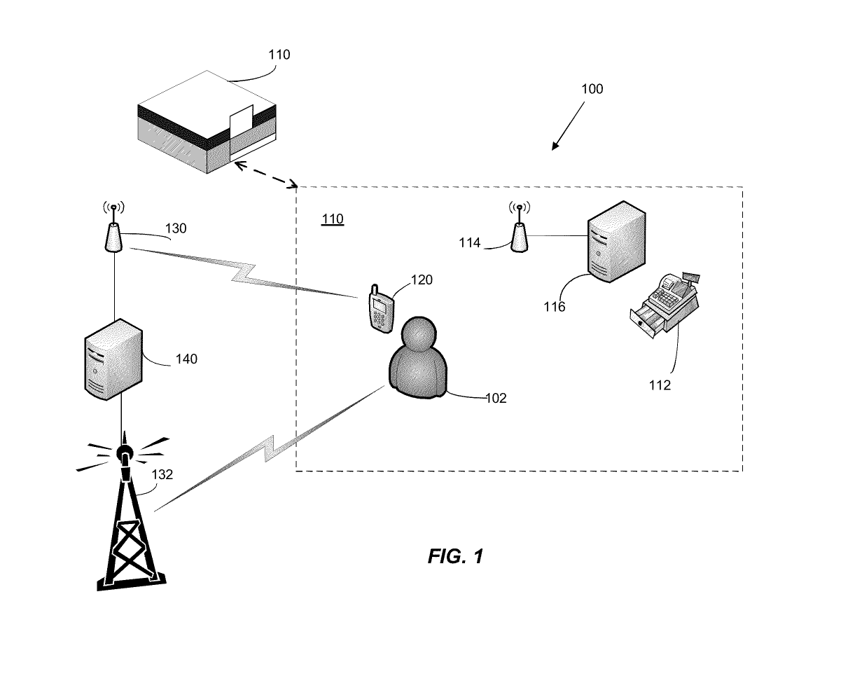

Thus, with reference to FIG. 1, a schematic diagram of an example system 100 configured to enable obtaining location-based data is shown. The system 100 includes an access point 114 that is located within a geographical area 110. Such a geographical area or localized environment may be, in some variations, a retail outlet (or retail environment, such as a mall), as indicated by a cash register 112 in FIG. 1. As used herein, the term “access point” refers to any device with the ability to transmit and/or receive wireless signals from one or more terminal devices and that may provide access to a network such as a local area network (LAN) or the Internet, or may otherwise facilitate communication in a wireless communication network. Such a WLAN may comprise a network compliant to or compatible with an IEEE 802.11x standard. In some embodiments, the access point 114 may include a node implementing a pico or femto cells, a Bluetooth-based node, etc. Thus, in some embodiments, the access point 114 may be part of, for example, a WiFi networks (802.11x), a cellular piconets and/or femtocells network, a Bluetooth network, etc. Although one (1) local access point 114 is depicted in FIG. 1, any number of such local access points (implementing the same, or different, communication technologies/protocols implemented by the access point 114) may be used.

In some embodiments, the access point may not be connected to a network, but instead may be configured to repeatedly transmit signals, that may include data identifying the access point, without establishing a communication link with any other device. In some implementations, the access point 114 may be coupled (directly, through physical wired connections, or wirelessly) to a server 116 that is configured to control the access point (e.g., configure the access point when required), and may also serve as an interface between the access point and a network (where the access point is coupled to a network) or a user.

As noted, the access point 114 may be configured to transmit signals, also referred to as beacon or control signals, that include data identifying the access point 114. For example, in some embodiments, the signals transmitted/broadcast by the access point 114 may include a service set identifier (SSID) data providing a pubic name for the access point or for the network to which it is connected. SSID data may constitute part of the information transmitted through beacon frames (e.g., in implementations in which the access point includes, for example, a WiFi-based access point), but additional data, such as time/timing information, may also be included in beacon frame signals transmitted by the local access point. Other data formats/configurations of data representative of an access point ID, which may be included in the access point's signals, may be used. As noted, the access point does not necessarily need to be coupled to a network, but rather may transmit signals providing an identification value associated with the access point 114. As will be discussed below, such identification information may be used to trigger operations at a receiving mobile device, without the mobile device establishing a communication link (or otherwise coupling to) the access point 114.

As further shown in FIG. 1, a mobile device 120 (carried by a user 102 in the example of FIG. 1) may come within the signal range of the access point 114, and may thus receive a signal from the access point 114. The term “mobile device” (or “wireless device,” “wireless terminal,” and/or “mobile station”) refers to any device that may communicate with other devices via wireless signals. Such devices may comprise mobile devices such as cellular telephones, or notebook or tablet computers, and may also include relatively stationary devices such as desktop computers. Such wireless devices/terminals may communicate via any of a range of wireless communication protocols. In some implementations, the mobile device 120's coarse location is repeatedly sampled/determined in such way that is not battery- or CPU-intensive (commonly through network resources), to thus establish the general vicinity of the device (e.g., determining that the mobile device is the general vicinity of the access point 114 when the device detects a signal from that access point). Detecting the signal from the access point may include identifying the access point based on data included in the signal that is representative of an identity of the access point. The mobile device's coarse location can thus be determined using signals from a single access point, and without needing to process signals from multiple transmitting devices. Establishing this coarse location of the mobile device 120 is performed without excessive and prolonged battery usage that is generally required to determine a more precise/refined location of the mobile device 120, thus preserving battery power of the device's battery. In some embodiments, subsequent to establishing the mobile device's coarse location, more refined location determination may be performed for the mobile device by determining the mobile device to be located in a defined area, to thus enable more refined data relating to the geographical area where the mobile device is positioned to be provided to the mobile device. For example, if the initial coarse location established for the mobile device indicates that the mobile device is inside or near a particular department store, data (e.g., marketing data) pertaining to that department store may be communicated to the device 120. Subsequent to determining that the mobile device 120 is located in or near the particular department store, the mobile device may perform additional location determination operations, e.g., based on multilateration position determination procedures, or some other procedure to more finely pinpoint the position of the mobile device. Based on the more refined determined position of the mobile device, data relating to the more refined positioned of the mobile device inside the geographical area in which it is located may be provided to the device 120, e.g., marketing data for a particular department in the department store (clothing department, furniture department, electronics department, etc.) where the device 120 was determined to be located based on the fine position determination operations performed subsequent to establishing the device's coarse location.

A more refined determination of the mobile device's position may be performed through various location-determination procedures/techniques. For example, the mobile device 120 may be configured to receive signals from one or more local or remote transmitters, such as the access point 114 and/or other access points (e.g., WiFi-based access points) deployed in the general area in which the mobile device 120 is location, and determine its position based, for example, on multilateration techniques. In some embodiments, the device's position may be determined using Received Signal Strength Indication (RSSI) computations, corresponding to power level computations of signals received at the mobile device from transmitters at known locations, or Round Trip Time (RTT) computations corresponding to the total time it takes to send a signal from the mobile device to a transmitter with a known location and receive in return a reply signal from that transmitter. The computed RSSI and/or RTT values can then be used to determine the mobile device position by performing a multilateration procedure with those computed values. In another example, the device's position may be determined based on signal profile identification techniques, e.g., by comparing computed values of, for example, RSSI and/or RTT, to stored profiles that are associated with pre-determined positions. In some implementations, the mobile device may compute RSSI and/or RTT values from signals received from other types of communication nodes (e.g., cellular-based communication nodes). Additionally, in some embodiments, the mobile device's position may be determined based on GPS signals received by a Satellite Position System (SPS) transceiver included with the mobile device 120.

With continued reference to FIG. 1, in response to detecting the signal from the access point 114, the mobile device 120 (or some other device configured to receive and detect signals from access points) obtains data associated with the geographical area (e.g., marketing data) without needing to establish a communications link to the access point 114. For example, the mobile device 120 may establish a communication link with a remote server 140 via a communication node (such as the communication nodes 130 and/or 132 shown in FIG. 1). As noted, in some embodiments, detecting the signal from the access point 114 may include receiving signals by the mobile device 120 executing a mobile-based application configured to determine if one or more of the received signals from a local access point (e.g., the access point 114) include data (provided in a control/beacon signal) representative of one or more predetermined access-point IDs identifying respective access points. Thus, upon determining that at least one of the received signals identifies an access point ID that matches a pre-determined access point ID maintained by an application running on the mobile device, the mobile device 120 is configured to establish a communication link with a communication node different from the access point from which it received the access point-identifying signals, in order to obtain data (e.g., from a remote server in communication with that node) pertaining to the locale where the mobile device is located. As such, the mobile device, when it establishes such a communication link to the remote server via the communication node, may serve as a personal mobile point-of-sale (POS) device. Because the mobile device establishes a communication link with the remote server via the communication node, the mobile device does not need to establish a link with the access point that triggered the actions by the mobile device 120 to establish a communication link with the communication node (e.g., the nodes 130 and/or 132).

The communication node with which the device 120 establishes a communication link may be a cellular communication node (also referred to as a base station or access point), such as the node 132 depicted in FIG. 1, used in implementations of Wide Area Network Wireless Access Points (WAN-WAP), which may be used for wireless voice and/or data communication. A wireless wide area network (WWAN) may be part of a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT.

In some implementations, the communication node 130 may include a LAN-based node, such as the access point 130 depicted in FIG. 1, to enable wireless LAN communication (e.g., WLAN, such as WiFi-based communications). Under such circumstances, the access point 130 may be part of a WLAN implemented as an IEEE 802.11x network. Generally, an access point such as the node 130 with which the mobile device establishes a communication link subsequent to determining its coarse position (e.g., by identifying an access point, such as the access point 114, from which it received identifying beacon or control signals, but without establishing a communication link with that access point) is part of a network (e.g., LAN network) that does not include the access point 114. As such, the access point 130 is generally independent of and unrelated to the access point 114.

Having established a communication link with the remote server 140 (via the communication nodes 130 and/or 132), the mobile device can receive data from the remote server. For example, the mobile device 120 can receive data associated with the geographical area 110 in which the access point 114 is located. Such data may be marketing data (e.g., promotional data) for a retail outlet corresponding to the area 110, or marketing data for various goods and services. The type of marketing data received may depend on information stored on the mobile device 120 (such information may be managed by the same mobile application that caused establishment of the communication link with the server 140 in response to detection of a signal from the access point 114). For example, the mobile device may store information about places visited by the device 120 (and thus by the user 102), personal information about the user 102, history of purchases made by the user 102, data searched for by the user through an interface (e.g., browser) installed on the device 120, etc. The server may store and send the data associated with the geographical area, or may contact other servers to retrieve appropriate data for transmission to the mobile device 120. As noted, by enabling a mobile device to quickly identify its coarse location based on signals receive from an access point deployed in the vicinity of the mobile device that identify the access point and can thus identify a particular entity associated with that location (e.g., a retail outlet), the mobile device can function as a mobile point-of-sale (POS) device through which it can receive marketing information, conduct transactions with the entity associated with the location, etc.

Thus, in some variations, selection or generation of the data to be sent to the mobile device 120 may be performed in a manner similar to that described in U.S. patent application Ser. No. 11/314,713, entitled “SYSTEMS AND METHODS FOR AUTOMATIC CONTROL OF MARKETING ACTIONS,” and U.S. patent application Ser. No. 12/697,867, entitled “PROCESSING OF COMMERCE-BASED ACTIVITIES”, the contents of all of which are hereby incorporated by reference in their entireties.

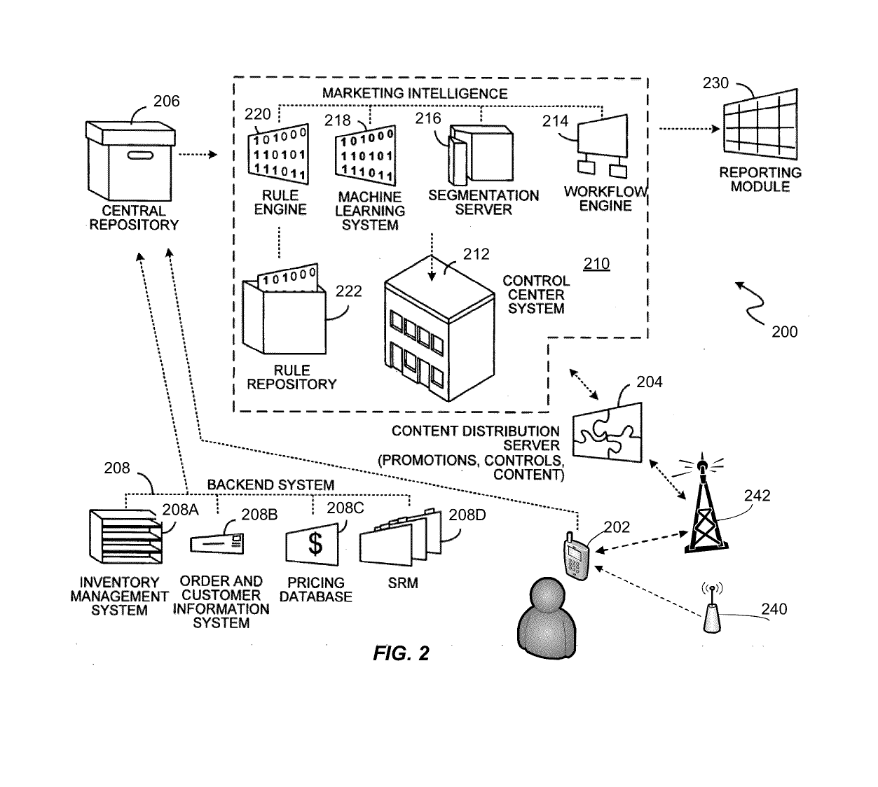

Briefly, and with reference to FIG. 2, a schematic diagram of a system 200 configured to enable obtaining location-based data so as to provide a mobile device with marketing and transaction data is shown. The system 200 includes a mobile Point-of-Sale (“POS”) device 202, which may be similar to the mobile device 120 depicted in FIG. 1, and thus is configured to receive control/identifying signals from local access points (e.g., local access point 240, which may be similar to the access point 114 of FIG. 1), determine from the received signal an identity of the access point, and determine whether the identified local access point (240 in the example of FIG. 2) matches one of one or more pre-determined access point identifiers maintained by an application executing on the mobile device 202. The mobile device 202 may thus be able to determine a coarse location based on signals from a single access point (e.g., without determining a more refined location based on signals from multiple transmitting devices). In response to a determination that the identity of the local access point 240 matches a pre-determined identification values maintained by an application running on the mobile device 202, the mobile device 202 establishes a communication link with a remote server 204 via, for example, a communication node 242, which may be a cellular communication node similar to the communication node 132 depicted in FIG. 1. In some embodiments, the server 204 may be a content distribution server configured to transmit to the mobile device general marketing information pertaining to the locale where the mobile device is determined to be located (based on the identity of the access point 240 whose signals were received by the mobile device). In some embodiments, the content transmitted from the remote server 204 to the mobile device may be based on information provided by the mobile device 202 to the server 204, including such information as the identity of the user, various particulars on the user (e.g., age, gender, address) that may be stored on the user's personal mobile device 202, and other information that may be relevant for determining content to send to the mobile device 202 (e.g., data stored on the mobile device regarding previous transactions made by the user, etc.)

In some embodiments, information collected by, or stored on, the mobile device 202 may be sent to a central repository 206 via the server 204 or directly to the central repository 206 (e.g., via a communication node(s) connecting the mobile device directly to the repository 206 without being routed via the server 204). The central repository 206 may include one or more servers where information from various POS systems, corresponding to one or more entities (e.g., different retail chains), various mobile devices, etc., are stored. The central repository 206 also receives information from the backend systems of the various entities whose content (marketing content, or otherwise) is to be distributed to POS systems. Example backend information systems 208a-d (operated by a particular entity) supplement the information collected from POS systems (e.g., stationary POS devices located on the premises of a particular entity and operated by that particular entity) and/or from mobile devices of users entering into the premises of the various entities providing data to the central repository 206. The supplemental data may include a particular entity's inventory levels at its various outlets, sales transactions, pricing information for the entity's various products and/or services, etc.

The data collected by the central repository 206 is then processed by a marketing intelligence system 210. The marketing intelligence system includes a workflow engine 214 which controls the operations executing on the various modules of the marketing intelligence system 210. The marketing intelligence system 210 includes a segmentation server 216 which retrieves records from the central repository 206 and places those records into segmented groups. The marketing intelligence system 210 also includes the rule engine 220 which, in some embodiments, is configured to apply rules, specifying marketing actions, based on a determination by a machine learning system 218 of whether the projected effectiveness that would result from the execution of those marketing actions would exceed a performance threshold. If the projected effectiveness matches or exceeds such a pre-defined threshold, the marketing actions defined in the rules are implemented on the various systems of system 200 affected by the marketing actions. For example, a possible rule could be one that specifies a marketing action of decreasing the prices for the products/services for particular products/services (which may be of interest to the user operating the mobile device 202) by 20%. The associated projected performance threshold level for the rule could be a 15% increase in sales volume. Thus, for that rule, the specified action would only be implemented if the projected effectiveness of implementing the rule would result in a 15% increase (or higher) in the sales volume for the products/services. The marketing actions thus adjust the marketing attributes of the affected products and services information produced by the marketing intelligence system 210. In some embodiments, the content sent to the various POS systems coupled to the system 210 (e.g., including sending content to the mobile device 202 via the server 204), possibly as a result of an implemented market action, may include coupons, promotional incentive data, etc. In some embodiments, content sent to POS systems (including the mobile device 202) may include content regarding purchases by other users with similar profiles. For example, the content provided to the mobile device may include data relating to purchases by users who previously had visited the same present location as that of the mobile device 202, data relating to purchases by users sharing similar timeframe information as the current user (for example, users who made purchases at the same time of the day as the current user), purchase data relating to users sharing similar purchasing habits, purchase data relating to users sharing similar demographics as the current user of the mobile device 202, etc. User control of the marketing intelligence system 210 is achieved using the control center system 212, and system reporting is performed via a reporting module 230.

In some embodiments, determination of the projected effectiveness for applying a marketing action specified in a rule may be performed by the machine learning system, such as the machine learning system 218 of FIG. 2, that accepts as input information provided by various POS systems (including, for example, the mobile device 202). If the computed projected effectiveness exceeds an associated performance threshold, the rule may be applied by the system 210. A machine learning system is a system that iteratively analyzes training input data and the input data's corresponding output, and derives functions or models that cause subsequent inputs to produce outputs consistent with the machine's learned behavior. In some embodiments, the learning machine system may be implemented based on a neural network system. A neural network includes interconnected processing elements (effectively the systems neurons). The connections between processing elements in the neural network have weights that cause output from one processing element to be weighed before being provided as input to the next interconnected processing elements. The weight values between connections can be varied, thereby enabling the neural network to adapt (or learn) in response to training data it receives. In some embodiments, the learning machine may be implemented as a support vector machine configured to generate, for example, classification functions or general regression function. In some embodiments, the learning machine may be implemented using decision trees techniques, regression techniques to derive best-fit curves, and/or other types of machine learning techniques.

System 200 can thus be used to control, for example, data/content sent and/or displayed on the mobile device 202 (and/or sent to other POS systems). For example, in response to input received by the marketing intelligence system 210 that is indicative of some variation in existing marketing conditions, data indicative of preferences of the user of the mobile device 202, and/or any other relevant data, the system 210 may determine that additional marketing promotion may in relation to one or more products/services, and/or coupons offering discounts on particular products/services sold at the outlet associated with the access point 240 (through which the mobile device 202 identified its coarse location) may be required. A marketing action affected by the marketing intelligence system may therefore cause adjustments and/or customization of the content directed to the mobile device 202.

As noted, in some implementations, the data sent to the mobile device may include more refined data that is more finely catered to a more refined position determined for the mobile device, subsequent to establishing a coarse location for the mobile device. In some embodiments, data associated with the geographical area in which the mobile device 120 or 202 was determined to be positioned may be provided to other devices/systems. For example, data (e.g., marketing data) may be sent to stationary point-of-sale (POS) devices in the vicinity of the mobile device. Thus, if the mobile device was determined to be located in a particular department store, data (e.g., marketing data) may be sent to in-store displays in the vicinity of the mobile device. In such implementations, content data relating to the area in which the user of the mobile device was determined to be located is presented on local stationary devices systems rather than directly on the mobile device. Such data sent to in-store displays may also be based on information pertaining to the mobile device or to the user of the mobile device, if such information is available. Further details about example POS devices and/or in-store displays are also provided in U.S. application Ser. Nos. 11/314,713 and 12/697,867 mentioned above.

As further noted, in some embodiments, obtaining data by the device 120 may include retrieving the data associated with the geographical area from the mobile device itself (the device 120 having previously stored such data for subsequent retrieval).

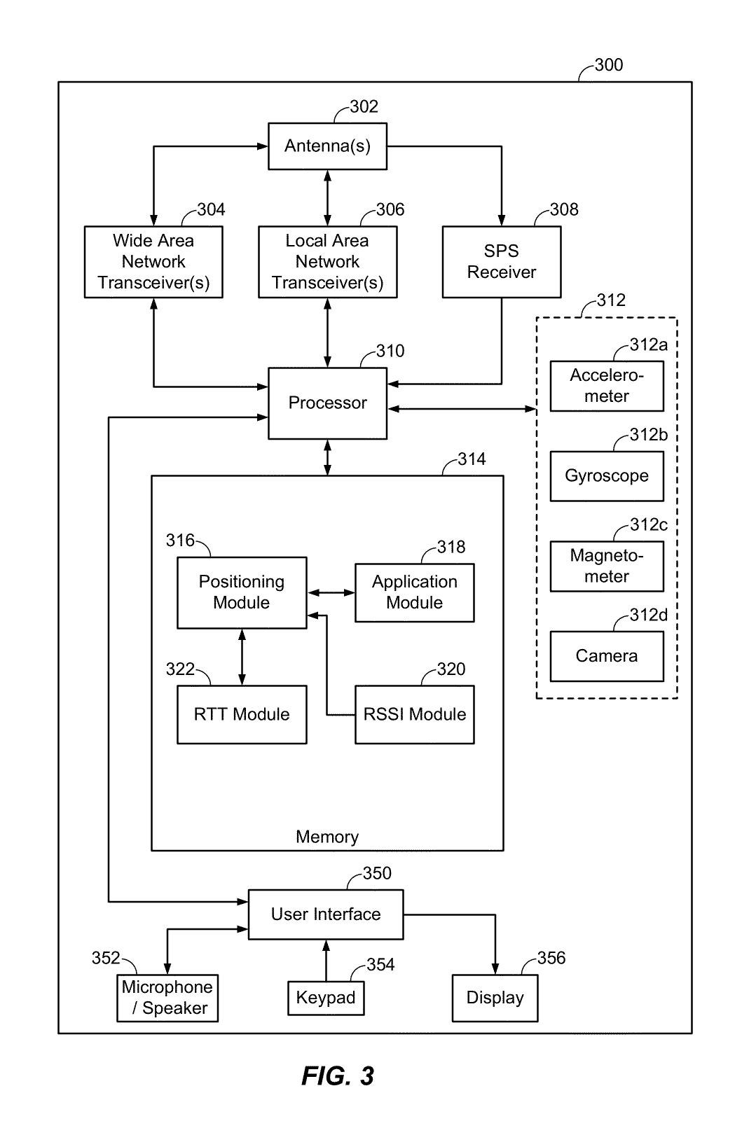

With reference now to FIG. 3, a schematic diagram illustrating various components of an example mobile device 300, which may be similar to the mobile devices 120 and 202 of FIGS. 1 and 2, respectively, is shown. For the sake of simplicity, the various features/components/functions illustrated in the diagram of FIG. 3 are connected together using a common bus to represent that these various features/components/functions are operatively coupled together. Other connections, mechanisms, features, functions, or the like, may be provided and adapted as necessary to operatively couple and configure a portable wireless device. Furthermore, one or more of the features or functions illustrated in the example of FIG. 3 may be further subdivided, or two or more of the features or functions illustrated in FIG. 3 may be combined. Additionally, one or more of the features or functions illustrated in FIG. 3 may be excluded.

As shown, the mobile device 300 may include one or more local area network transceivers 306 that may be connected to one or more antennas 302. The one or more local area network transceivers 306 comprise suitable devices, hardware, and/or software for communicating with and/or detecting signals to/from, for example, the access points 114 and 130 depicted in FIG. 1, and the access point 240 depicted in FIG. 2. In some embodiments, the local area network transceiver(s) 306 may comprise a WiFi (802.11x) communication transceiver suitable for communicating with one or more wireless access points; however, in some embodiments, the local area network transceiver(s) 306 may be configured to communicate with other types of local area networks, personal area networks (e.g., Bluetooth), etc. Additionally, any other type of wireless networking technologies may be used, for example, ZigBee, wireless USB, etc.

The mobile device 300 may also include, in some implementations, one or more wide area network transceiver(s) 304 that may be connected to the one or more antennas 302. The wide area network transceiver 304 may comprise suitable devices, hardware, and/or software for communicating with and/or detecting signals from one or more of, for example, the communication nodes 132 and 242 illustrated in FIGS. 1 and 2, respectively, and/or directly with other wireless devices within a network. In some implementations, the wide area network transceiver(s) 304 may comprise a CDMA communication system suitable for communicating with a CDMA network of wireless base stations. In some implementations, the wireless communication system may comprise other types of cellular telephony networks, such as, for example, TDMA, GSM, etc. Additionally, any other type of wireless networking technologies may be used, including, for example, WiMax (802.16), etc.

In some embodiments, an SPS receiver (also referred to as a global navigation satellite system (GNSS) receiver) 308 may also be included with the mobile device 300. The SPS receiver 308 may be connected to the one or more antennas 302 for receiving satellite signals. The SPS receiver 308 may comprise any suitable hardware and/or software for receiving and processing SPS signals. The SPS receiver 308 may request information, as appropriate, from other systems, and may perform the computations necessary to determine the position of the mobile device 300 using, in part, measurements obtained by any suitable SPS procedure.

In some embodiments, the mobile device 300 may also include one or more sensors 312 coupled to a processor 310. For example, the sensors 312 may include motion sensors (also referred to as inertial sensors) to provide relative movement and/or orientation information which is independent of motion data derived from signals received by the wide area network transceiver(s) 304, the local area network transceiver(s) 306, and/or the SPS receiver 308. By way of example but not limitation, the motion sensors may include an accelerometer 312a, a gyroscope 312b, a geomagnetic (magnetometer) sensor 312c (e.g., a compass), an altimeter (e.g., a barometric pressure altimeter, not shown), and/or other sensor types.

The output of the one or more sensors 312 may be combined in order to provide motion information. For example, estimated position of the mobile device 300 may be determined based on a previously determined position and the distance traveled from that previously determined position as determined from the motion information derived from measurements by at least one of the one or more sensors. As further shown in FIG. 3, in some embodiments, the one or more sensors 312 may also include a camera 312d (e.g., a charge-couple device (CCD)-type camera), which may produce still or moving images (e.g., a video sequence) that may be displayed on a user interface device, such as a display or a screen.

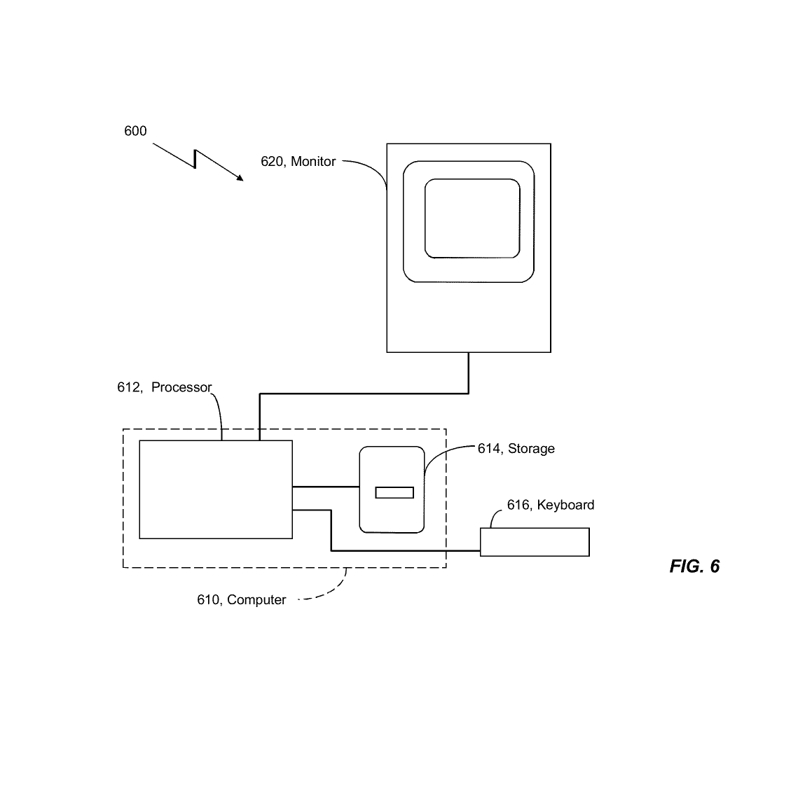

The processor(s) (also referred to as a controller) 310 may be connected to the local area network transceiver(s) 306, the wide area network transceiver(s) 304, the SPS receiver 308, and/or the one or more sensors 312. The processor may include one or more microprocessors, microcontrollers, and/or digital signal processors that provide processing functions, as well as other calculation and control functionality. The processor 310 may also include storage media (e.g., memory) 314 for storing data and software instructions for executing programmed functionality within the mobile device. The memory 314 may be on-board the processor 310 (e.g., within the same IC package), and/or the memory may be external memory to the processor and functionally coupled over a data bus. Further details regarding an example embodiment of a processor or computation system, which may be similar to the processor 310, are provided below in relation to FIG. 6.

A number of software modules and data tables may reside in memory 314 and be utilized by the processor 310 in order to manage both communications with remote devices/nodes (such as the various access points depicted in FIG. 1), positioning determination functionality, and/or device control functionality. As noted, the processor 310 may be configured, for example, to enable detection of incoming signals from a local access point (e.g., WiFi beacon signals received by the transceiver 306 of FIG. 3), determine the identity of the access point transmitting the signals, determine whether the access point identity matches one of pre-determined access point identifiers the mobile device is configured to recognize and to take action in response thereto, and receive data via its transceiver 304 from a communication node, different from the access point that sent the identifying signals, corresponding to an area associated with the detected access point.

As illustrated in FIG. 3, in some implementations, the memory 314 may include, for example, a positioning module 316, an application module 318 executing various software applications (that typically run within an upper layer of the software architectures), a received signal strength indicator (RSSI) module 320, and/or a round trip time (RTT) module 322. It is to be noted that the functionality of the modules and/or data structures may be combined, separated, and/or be structured in different ways depending upon the implementation of the mobile device 300. For example, the RSSI module 320 and/or the RTT module 322 may each be realized, at least partially, as a hardware-based implementation, and may thus include such devices as a dedicated antenna (e.g., a dedicated RTT and/or RSSI antenna), a dedicated processing unit to process and analyze signals received and/or transmitted via the antenna(s) (e.g., to determine signal strength of a received signals, determine timing information in relation to an RTT cycle), etc.

The application module 318 may include an interface process running on the processor 310 of the mobile device 300, which receives data representative of identity of access points (e.g., SSID data included in a beacon frame), determines if a received identity data matches one of one or more predetermined access point identities maintained by the application, and when a received identity matches one such predetermined access point identities, to request and receive from a remote server (via, for example, a cellular transceiver such as the transceiver 304 of FIG. 3) data associated with the geographical area in which the identified access point is located. As noted, in some embodiments, the data requested from, and sent by, a remote server may be marketing data such as market data generated by the system 210 of FIG. 2. Under such circumstances, the remote server/system may generate marketing data, including product and service information, various promotions, etc., that are customized for the user of the mobile device 300. Such marketing data may thus also be generated based on user information (e.g., previous purchases, previous product information reviewed by the user, etc.) collected and/or stored on the mobile device 300, and provided to the remote server/system with the request for data sent in response to detecting (including identifying) an access point in the vicinity of the mobile device 300. As further noted, in situations where the data provided by the remote server/system to the mobile device is marketing data related to the locale where the mobile device is currently located, the interface process of the application module 318 may be a POS application configured to function as a mobile POS unit that enables the user to review marketing data relevant to the particular locale where the user is located, and/or to enable the user to enter into transactions in relation to products and services corresponding to the marketing data received on the device 300.

The positioning module 316 may derive the position of the mobile device 300 using information derived from various receivers and modules of the mobile device 300. For example, to determine the mobile device's position based on RTT measurements, reasonable estimates of processing time delays introduced by each communication device may first be obtained and used to calibrate/adjust the measured RTTs. The measured RTTs may be determined by the RTT module 322, which can measure the timings of signals exchanged between the mobile device 300 and the access points to derive round trip time (RTT) information. In some embodiments, once measured, the RTT values may be passed to the positioning module 316 to assist in determining the position of the mobile device 300. Position determination may also be performed based on, for example, RSSI measurements made by the RSSI module 320. Positioning data determined by the position module 316 may be provided to the application module 318, which may use that data in conjunction with the applications of the module 318. For example, positioning data may be provided to the interface process to refine a previously determined coarse location (determined based on detecting signals identifying a particular access point(s)).

The mobile device 300 may further include a user interface 350 which provides suitable interface systems, such as a microphone/speaker 352, keypad 354, and a display 356 that allows user interaction with the mobile device 300. The microphone/speaker 352 provides for voice communication services (e.g., using the wide area network transceiver(s) 304 and/or the local area network transceiver(s) 306). The keypad 354 comprises any suitable buttons for user input. The display 356 comprises any suitable display, such as, for example, a backlit LCD display, and may further include a touch screen display for additional user input modes.

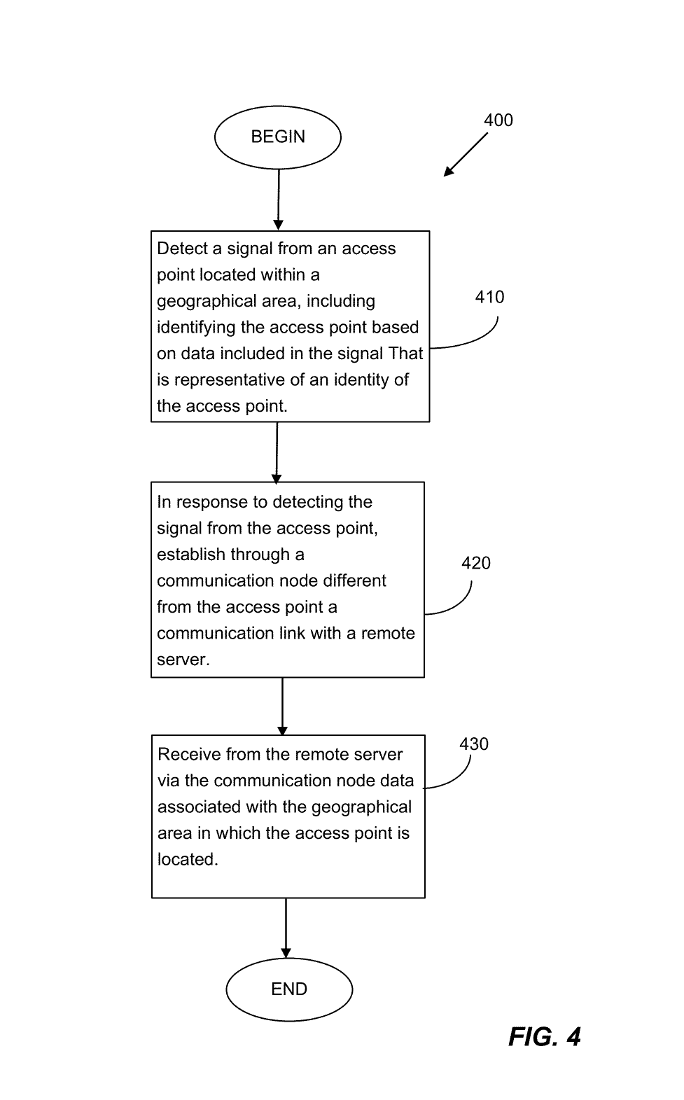

With reference now to FIG. 4, a flowchart of an example procedure 400 to perform location-based data procurement is shown. The procedure 400 includes detecting 410 a signal from an access point (such as the access point 114 of FIG. 1) located within a geographical area, including identifying the access point based on data included in the signal representative of an identity of the access point. For example, detecting the signal may include receiving beacon/control signals from the access point that is configured to transmit such signals without enabling establishment of a communication link with devices receiving its beacon/control signals, and determining an identity of the transmitting access point from the received data (e.g., processing the received data and reading/decoding SSID data included in the processed received signal). Thus, a coarse location of a mobile device may be established based on a signal received from a single access point once the mobile device has come within transmission range of the access point (i.e., it is not necessary to establish a more refined location based on processing performed on signals from multiple access points and/or other nodes).

In response to detecting the signal from the access point, a communication link with a remote server is established 420 through a communication node that is different from the first access point that transmitted the area-identifying signal(s). As noted, in some embodiments, the communication link is established via a cellular node (e.g., base station) from which the remote server can be accessed. Having established the communication link with the remote server, data associated with the geographical area in which the access point is located is received 430 from the remote server via the communication node. In some embodiments, the received data may be marketing data related to the geographic area in which the access point is located. The geographical area may be, for example, an outlet of a commercial entity (e.g., a retail store), and the data received by the mobile device (and presented on a user interface on the device) may be marketing data for the particular outlet.

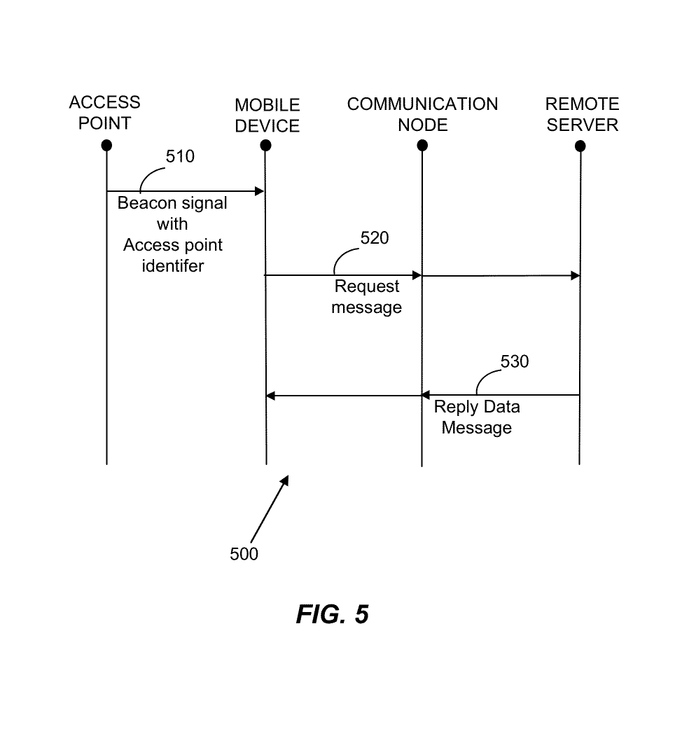

Operations performed by the systems of FIGS. 1 and 2 are further illustrated with reference to FIG. 5, showing an example signal diagram 500 of example transmissions made by the mobile device and the devices it interacts/communicates with. As illustrated, an access point, such as the access points 114 and 240 of FIGS. 1 and 2, respectively, may transmit control signals 510 (e.g., beacon signals) including information identifying the access point. The access point is associated with a particular geographic area (which may correspond to the premises of a commercial entity, such as a retail outlet). A mobile device, such as the mobile devices 120, 202, and/or 300 of FIGS. 1, 2, and 3, respectively, that comes within range of the transmitting access point may receive the transmission and determine from the transmission an identifier associated with the transmitting access point. In some embodiments, the mobile device may determine (e.g., using an application executing on the mobile device) that the determined access point identifier value matches one of one or more predetermined access point identifier values maintained by the application.

When there is an access point identifier value match, the mobile device may initiate communication with a communication node that is different from the access point that transmitted the control signals, e.g., a cellular-type communication node, by transmitting a request message 520 to the communication node. Thus, the mobile device does not attempt to establish a communication link with the access point. Rather, the access point may serve simply to broadcast information that identifies a geographical area associated with the access point. The request sent to the communication node may include information to access and establish a communication link with a remote server that can provide data relating to the geographic area associated with the access point. The particulars of the remote server (e.g., its network address) may have been specified by the application running on the mobile device that is used to determine if the access point identifier values match one of one or more predetermined access point identifier values. In some embodiments, the request message and/or subsequent messages sent by the mobile device to the remote server via the communication node may include user-specific data corresponding to the user of the mobile device that enables the remote server to generate and provide data relating to the geographic area associated with the access point that is individually customized to the user of the mobile device.

The communication node receiving the request message 520 from the mobile device forwards the request message (or some resultant message processed by the communication node) to the remote server. As noted, responsive to the request message, the remote server may generate user-specific data, or general data, corresponding to the geographic area in which the mobile device and its user are located (as determined from the access point that transmitted the control/beacon message 510). In some embodiments, the data (user-specific or general) may be marketing data to be presented to the user. The data is transmitted in a reply data message 530 to the mobile device via the communication node and presented on the mobile device (e.g., using a user interface that may be part of the application that originally recognized the access point identifier value sent by the access point).

Performing the various operations described herein may be facilitated by a processor-based computing system. Particularly, at least some of the various systems/devices described herein may be implemented using one or more processing-based devices. Thus, with reference to FIG. 6, a schematic diagram of a generic computing system 600 is shown. The computing system 600 includes a processor-based device 610 such as a personal computer, a specialized computing device, and so forth, that typically includes a central processor unit 612. In addition to the CPU 612, the system includes main memory, cache memory and bus interface circuits (not shown). The processor-based device 610 may include a mass storage element 614, such as a hard drive or flash drive associated with the computer system. The computing system 600 may further include a keyboard, or keypad, or some other user input interface 616, and a monitor 620, e.g., a CRT (cathode ray tube) or LCD (liquid crystal display) monitor, that may be placed where a user can access them.

The processor-based device 610 is configured to facilitate, for example, the implementation of operations to detect signals from an access point located within a geographical area, and establish a communication link with a remote server via another communication node to obtain data associated with the geographical area from the remote server, as well as perform other general computer-based operations. The storage device 614 may thus include a computer program product that when executed on the processor-based device 110 causes the processor-based device to perform operations to facilitate the implementation of the above-described procedures. The processor-based device may further include peripheral devices to enable input/output functionality. Such peripheral devices may include, for example, a CD-ROM drive and/or flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, etc., may be used in the implementation of the system 600. Other modules that may be included with the processor-based device 610 are speakers, a sound card, a pointing device, e.g., a mouse or a trackball, by which the user can provide input to the computing system 600. The processor-based device 610 may include an operating system, e.g., Windows XP® Microsoft Corporation operating system. Alternatively, other operating systems could be used.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Some or all of the subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an embodiment of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server generally arises by virtue of computer programs running on the respective computers and having a client-server relationship to each other.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A method comprising:
detecting a signal from an access point located within a geographical area, including identifying the access point based on data included in the signal representative of an identity of the access point;
in response to detecting the signal from the access point, establishing through a communication node, different from the access point, a communication link with a remote server; and
receiving from the remote server via the communication node data associated with the geographical area in which the access point is located.

2. The method of claim 1, wherein the access point includes a WiFi-based access point.

3. The method of claim 1, wherein the communication node comprises a cellular-based communication node.

4. The method of claim 1, wherein the geographical area includes a retail outlet.

5. The method of claim 4, wherein receiving the data associated with the geographical area comprises:
receiving from the remote server via the communication node marketing data relating to the retail outlet, the marketing data comprising one or more of: marketing promotional data, or data relating to purchases by various users.

6. The method of claim 1, wherein detecting the signal comprises:
receiving the signal by a mobile device executing a mobile-based application configured to determine if one or more of received signals include one or more predetermined access-point IDs identifying respective access points; and
determining whether the received signal includes data representative of one of the one or more predetermined access-point IDs.

7. A mobile device comprising:
one or more processor-based devices; and
memory storage devices to store instructions that when executed on the one or more processor-based devices cause operations comprising:
detecting a signal from an access point located within a geographical area, including identifying the access point based on data included in the signal representative of an identity of the access point;
in response to detecting the signal from the access point, establishing through a communication node, different from the access point, a communication link with a remote server; and
receiving from the remote server via the communication node data associated with the geographical area in which the access point is located.

8. The mobile device of claim 7, wherein the access point includes a WiFi-based access point.

9. The mobile device of claim 7, wherein the communication node comprises a cellular-based communication node.

10. The mobile device of claim 7, wherein the geographical area includes a retail outlet.

11. The mobile device of claim 10, wherein receiving the data associated with the geographical area comprises:
receiving from the remote server via the communication node marketing data relating to the retail outlet, the marketing data comprising one or more of: marketing promotional data, or data relating to purchases by various users.

12. The mobile device claim 1, wherein detecting the signal comprises:
processing the signal using a mobile-based application executing on the mobile device, the mobile-based application configured to determine if one or more received signals include one or more predetermined access-point IDs identifying respective access points; and
determining whether the received signal includes data representative of one of the one or more predetermined access-point IDs.

13. A non-transitory computer readable media programmed with a set of instructions executable on a processor that, when executed, cause operations comprising:
detecting a signal from an access point located within a geographical area, including identifying the access point based on data included in the signal representative of an identity of the access point;
in response to detecting the signal from the access point, establishing through a communication node, different from the access point, a communication link with a remote server; and
receiving from the remote server via the communication node data associated with the geographical area in which the access point is located.

14. The computer readable media of claim 13, wherein the access point includes a WiFi-based access point, and wherein the communication node comprises a cellular-based communication node.

15. The computer readable media of claim 13, wherein the geographical area includes a retail outlet.

16. The computer readable media of claim 15, wherein receiving the data associated with the geographical area comprises:
receiving from the remote server via the communication node marketing data relating to the retail outlet, the marketing data comprising one or more of: marketing promotional data, or data relating to purchases by various users.

17. The computer readable media of claim 13, wherein detecting the signal comprises:
receiving the signal by a mobile device executing a mobile-based application configured to determine if one or more of received signals include one or more predetermined access-point IDs identifying respective access points; and
determining whether the received signal includes data representative of one of the one or more predetermined access-point IDs.

18. A method comprising:
detecting a signal from an access point located within a geographical area, including identifying the access point based on data included in the signal representative of an identity of the access point; and
in response to detecting the signal from the access point, obtaining data associated with the geographical area without establishing a communications link with the access point.

19. The method of claim 18, wherein obtaining the data associated with the geographical area comprises:
establishing through a communication node, different from the access point, a communication link with a remote server; and
receiving from the remote server via the communication node data associated with the geographical area in which the access point is located.

20. The method of claim 18, wherein obtaining the data associated with the geographical area comprises:
retrieving from a mobile device that detected the signal from the access point the data associated with the geographical area.
